(19) United States
(12) Patent Application Publication
(10) Pub. No.: US 2005/0125699 A1
(43) Pub. Date: Jun. 9, 2005

(54) SARTS PASSWORD MANAGER

(76) Inventor: Raymond Harper, Covington, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(21) Appl. No.: 10/729,293

(22) Filed: Dec. 5, 2003

(51) Int. Cl. G05D 23/13

(52) U.S. Cl. 713/202

(57) ABSTRACT

An password management system is provided. The system typically includes a graphical user interface logic, which receives a current password from a user, prompts the user to determine whether to change the current password, and receive a new password if the user replies affirmatively. The system further includes password confirmation logic to confirm the current password with a switched access remote test system, and password administration logic to receive the new password and change the current password on the switched access remote test system. Methods and other systems are also provided.

### FIELD OF THE DISCLOSURE

The present disclosure is generally related to remote testing systems and more particularly to password management on a switched access remote testing system.

### DESCRIPTION OF THE RELATED ART

As communication systems become more complex, it has become necessary to provide higher level abstractions from those communications systems. The switched access remote test system (SARTS), available from Lucent Technologies, Inc. of Murray Hill, N.J., was an early attempt at abstraction for testing frame relay circuits. SARTS typically operates on a Unix-based operating system such as Solaris, which is available from Sun Microsystems, Inc. of Santa Clara, Calif.

As often occurs, later stages of development migrated away from these earlier attempts at providing a test system for frame relay circuits. In particular, an integrated testing and analysis system (INTAS) was developed by Telcordia Technologies, Inc., of Piscataway, N.J., to provide a more user friendly frame relay test system. INTAS is a software solution that rides on top of the SARTS application, providing a more user-friendly interface for users. However, this abstraction results in users having a very difficult time using the actual SARTS application in situations where INTAS does not provide a solution. One such instance is the SARTS password maintenance features. In particular, the SARTS application requires that users change their passwords frequently. When a user does not change his or her password, the user becomes locked out of the SARTS application, and thus, by association, the INTAS system as well. Moreover, the SARTS application can be unforgiving for novice or unfamiliar users, providing trouble for those who may try to change their password. Therefore, there is a need for systems and methods that address these and/or other perceived shortcomings prior systems.

### SUMMARY OF THE DISCLOSURE

One embodiment, among others, of the present disclosure provides for a password management system. A representative system, among others, includes a graphical user interface, password confirmation logic and password administration logic. The graphical user interface logic typically receives a current password from a user, prompts the user to determine whether to change the current password, and receives a new password responsive to the determination. The password confirmation logic typically confirms the current password with a switched access remote test system. The password administration logic typically receives the new password and changes the current password on the switched access remote test system (SARTS) in response to the determination and confirmation of the current password.

A representative method for password management, among others, includes the following steps: providing a user with a graphical user interface; receiving a current password from the user via the graphical user interface for a switched access remote test system; prompting the user on whether to change the current password; receiving a new password from the user responsive to the user response to the prompting; confirming the current password with the switched access remote test system; and, requesting that the switched access remote test system change the password responsive to the user response to the prompting.

Other systems, methods, and/or computer programs products according to embodiments will be or become apparent to one with skill in the art upon review of the following drawings and detailed description. It is intended that all such additional system, methods, and/or computer program products be included within this description, be within the scope of the present disclosure, and be protected by the accompanying claims.

### BRIEF DESCRIPTION OF THE DRAWINGS

The disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows a block diagram illustrating a typical network structure that includes the SARTS application.

FIG. 2 shows a generic block diagram of the server of FIG. 1 that includes the SARTS application.

FIG. 3 shows a generic block diagram of the computer of FIG. 1 including an embodiment of the password manager.

FIG. 4 shows a flowchart illustrating an embodiment, among others, of the password manager of FIG. 3.

### DETAILED DESCRIPTION OF THE PREFERRED EMBODIMENTS

The disclosure now will be described more fully with reference to the accompanying drawings. The disclosure may, however, be embodied in many different forms and should not be construed as limited to the embodiments set forth herein; rather, these embodiments are intended to convey the scope of the disclosure to those skilled in the art. Furthermore, all “examples” given herein are intended to be non-limiting.

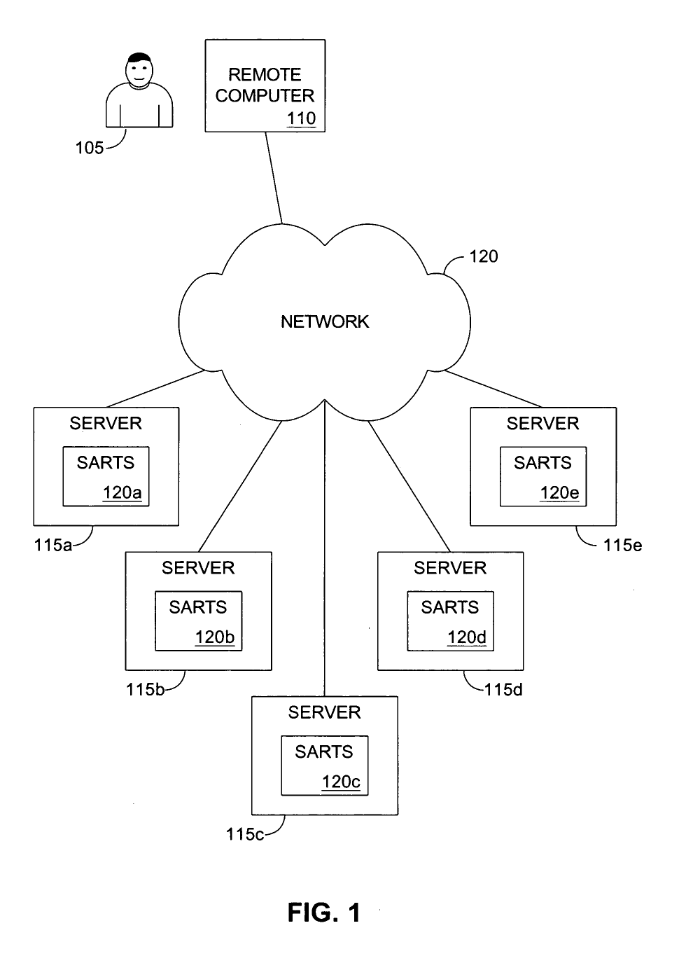

Referring to FIG. 1, shown is a block diagram illustrating a typical network structure including the switched access remote test system (SARTS). Typically a user 105 accesses a SARTS application through a remote computer 110. The remote computer typically includes an X Window terminal (xterm) terminal emulation which allows the remote computer to interface with a remotely located X Window system server 115a-e, which includes the SARTS application 120a-e. The X Window system is a graphical user interface (GUI) for Unix-based operating systems, and is available from Sun Microsystems, Inc., of Santa Clara, Calif. The remote computer typically communicates with the remotely located servers 115a-e through a network 120. One skilled in the art should understand that, in various implementations, among others, the connection to the network is any of a variety of different types of connections which are known in the art, including, among others: ethernet, digital subscriber line (DSL), integrated services digital network (ISDN), asynchronous transfer mode (ATM), synchronous optical network (SONET), T-carrier, etc.

When the user 105 opens the xterm window on the remote computer 110 and opens a connection to a server 115, the user is able to run any of the programs located at that computer. In this example, among others, the user 105 chooses to run the SARTS application 120a-e. The SARTS application 120a-e is a Unix based program that allows the user to run tests on frame relay circuits coupled to the servers, to monitor the frame relay circuits for trouble. Alternatively, the user 105 chooses to run INTAS, which is a user-friendly application that rides on top of the SARTS application 120a-e. The server 115 will run the program, providing information back to the user 105 through the xterm terminal emulation.

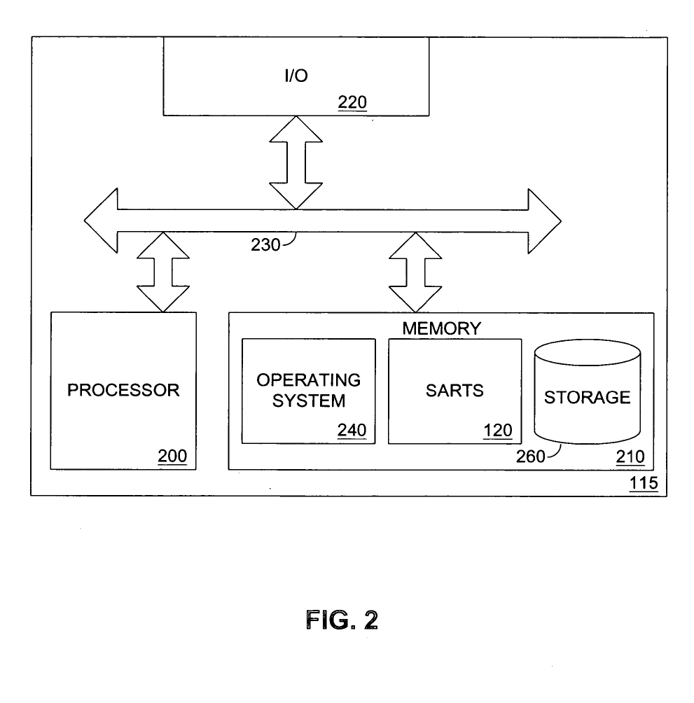

Referring now to FIG. 2, shown is a generic block diagram of the server 115a-e of FIG. 1. Generally, in terms of hardware architecture, as shown in FIG. 2, the server 115 includes a processor 200, memory 210, and one or more input and/or output (I/O) devices 220 (or peripherals) that are communicatively coupled via a local interface 230. The local interface 230 is, for example but not limited to, one or more buses or other wired or wireless connections, as is known in the art. The local interface 230 in some implementations has additional elements, which are omitted for simplicity, such as controllers, buffers (caches), drivers, repeaters, and receivers, to enable communications. Further, the local interface in various embodiments, among others, includes address, control, and/or data connections to enable appropriate communications among the aforementioned components.

The processor 200 is a hardware device for executing software, particularly that stored in memory 210. The processor 200 in various implementations, is any custom made or commercially available processor, a central processing unit (CPU), an auxiliary processor among several processors associated with the server 115, a semiconductor based microprocessor (in the form of a microchip or chip set), a macroprocessor, or generally any device for executing software instructions.

The memory 210 includes any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 210 in various implementations incorporates electronic, magnetic, optical, and/or other types of storage media. Note that in some embodiments, among others, the memory 210 has a distributed architecture, where various components are situated remote from one another, but can be accessed by the processor 200.

The software in memory 210 typically includes one or more separate programs 240, 120, each of which comprises an ordered listing of executable instructions for implementing logical functions. In the example of FIG. 2, the software in the memory 210 includes the SARTS application 120 and a suitable operating system (O/S) 240. A nonexhaustive list of examples of suitable commercially available operating systems 240 is as follows: (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc. The operating system 240 essentially controls the execution of other computer programs, such as the SARTS application 120, and provides scheduling, input-output control, file and data management, memory management, and communication control and related services.

The SARTS application 120 is a source program, executable program (object code), script, or any other entity comprising a set of instructions to be performed. When a source program, then the program needs to be translated via a compiler, assembler, interpreter, or the like, which may or may not be included within the memory 210, so as to operate properly in connection with the O/S 240. Furthermore, the SARTS application 120 in various implemenations, is written as (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The I/O devices 220 typically includes input devices, for example but not limited to, a keyboard, mouse, scanner, microphone, etc. Furthermore, the I/O devices 220 typically also includes output devices, for example but not limited to, a printer, display, etc. Finally, the I/O devices 220 in some implementations further includes devices that communicate both inputs and outputs, for instance but not limited to, a modulator/demodulator (modem; for accessing another device, system, or network), a radio frequency (RF) or other transceiver, a telephonic interface, a bridge, a router, etc.

The software in the memory 210 typically further includes a basic input output system (BIOS) (omitted for simplicity). The BIOS is a set of essential software routines that initialize and test hardware at startup, start the O/S 240, and support the transfer of data among the hardware devices. The BIOS is stored in ROM so that the BIOS is typically executed when the server 115 is activated.

When the server 115 is in operation, the processor 200 is configured to execute software stored within the memory 210, to communicate data to and from the memory 210, and to generally control operations of the server 115 pursuant to the software. The SARTS application 120 and the O/S 240, in whole or in part, but typically the latter, are read by the processor 200, perhaps buffered within the processor 200, and then executed.

When the SARTS application 120 is implemented in software, as is shown in FIG. 2, it should be noted that the SARTS application 120, in various implementations, is stored on any computer readable medium for use by or in connection with any computer related system or method. In the context of this document, a computer readable medium is an electronic, magnetic, optical, or other physical device or means that contains or stores a computer program for use by or in connection with a computer related system or method. The SARTS application 120, in some implementations, is be embodied in any computer-readable medium for use by or in connection with an instruction execution system, apparatus, or device, such as a computer-based system, processor-containing system, or other system that fetches the instructions from the instruction execution system, apparatus, or device and execute the instructions. In the context of this document, a “computer-readable medium” is any means that stores, communicates, propagates, or transports the program for use by or in connection with the instruction execution system, apparatus, or device. The computer readable medium is, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium in some implementations is paper or another suitable medium upon which the program is printed, as the program can be electronically captured, via for instance optical scanning of the paper or other medium, then compiled, interpreted or otherwise processed in a suitable manner if necessary, and then stored in a computer memory.

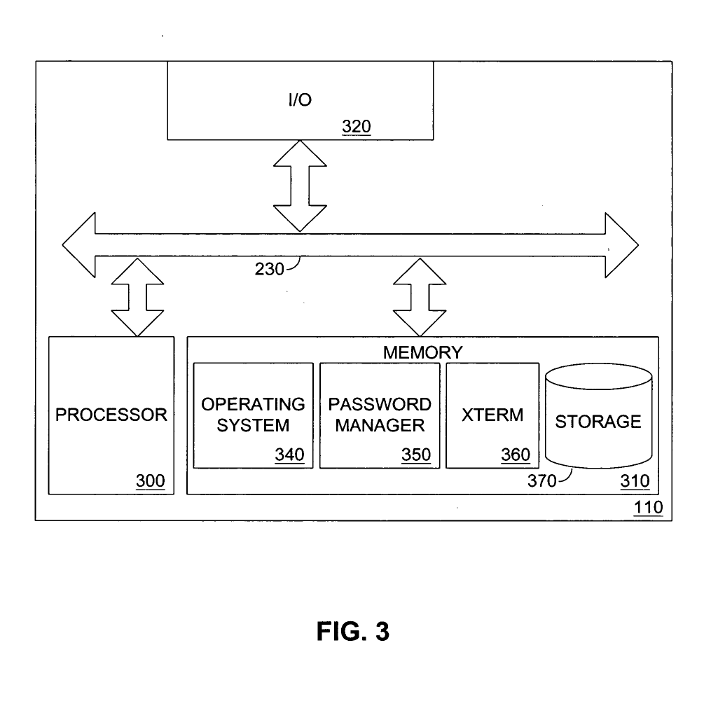

Referring now to FIG. 3, shown is a generic block diagram of the computer 110 of FIG. 1. Similarly to FIG. 2, in terms of hardware architecture, as shown in FIG. 3, the computer 110 includes a processor 300, memory 310, and one or more input and/or output (I/O) devices 320 (or peripherals) that are communicatively coupled via a local interface 330. Each of the elements in the computer are similar to those as described with respect to FIG. 2, and as known in the art.

The software in memory 310 typically includes one or more separate programs 340, 350, 360, each of which comprises an ordered listing of executable instructions for implementing logical functions. In the example of FIG. 3, the software in the memory 310 includes the password manager 350, an xterm program 360, and a suitable operating system (O/S) 340. Examples of suitable operating systems are the same as those described with respect to FIG. 2.

The password manager 350 is a source program, executable program (object code), script, or any other entity comprising a set of instructions to be performed. When a source program, then the program needs to be translated via a compiler, assembler, interpreter, or the like, which may or may not be included within the memory 310, so as to operate properly in connection with the O/S 340. Furthermore, the password manager 350 in various implementations written as (a) an object oriented programming language, which has classes of data and methods, or (b) a procedure programming language, which has routines, subroutines, and/or functions, for example but not limited to, TCL/TK with Expect, C, C++, Pascal, Basic, Fortran, Cobol, Perl, Java, and Ada.

When the password manager 350 is implemented in software, as is shown in FIG. 3, it should be noted that the password manager 350 in some implementations, among others, is stored on any computer readable medium for use by or in connection with any computer related system or method. In the context of this document, a computer readable medium is an electronic, magnetic, optical, or other physical device or means that contains or stores a computer program for use by or in connection with a computer related system or method. The password manager 350 is typically embodied in any computer-readable medium for use by or in connection with an instruction execution system, apparatus, or device, such as a computer-based system, processor-containing system, or other system that fetches the instructions from the instruction execution system, apparatus, or device and execute the instructions. In the context of this document, a “computer-readable medium” is any means that can store, communicate, propagate, or transport the program for use by or in connection with the instruction execution system, apparatus, or device. The computer readable medium is, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium in some embodiments, among others, is paper or another suitable medium upon which the program is printed, as the program is operable to be electronically captured, via for instance optical scanning of the paper or other medium, then compiled, interpreted or otherwise processed in a suitable manner if necessary, and then stored in a computer memory.

Moreover, the storage 370 in some embodiments, among others, includes a password file that stores information regarding the user's 105 password, and the last time it was changed. The password manager 350, in one embodiment, among others, reads the password file, and determine whether the user's password is approaching its expiration. The password manager 350 prompts the user to change his or her password upon determining that the password is approaching its expiration. However, it should be appreciated that in some embodiments, among others, of the present disclosure, the password is not stored in the password file because of security concerns. In this instance, the password manager 350 would prompts the user for his or her password prior to logging onto the SARTS system.

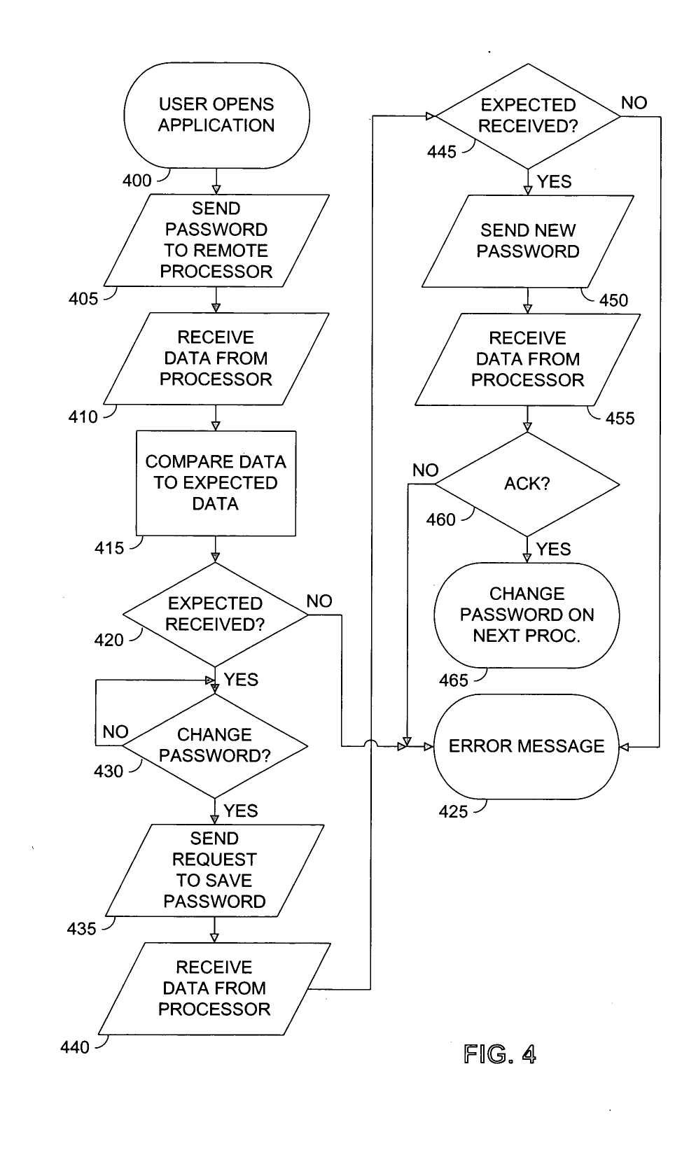

Further, the password manager 350 typically opens a connection to SARTS using an xterm window and provide a user-friendly application which allows the user to change his or her the SARTS password. Referring now to FIG. 4, shown is a flowchart illustrating an embodiment, among others, of the password manager of FIG. 3. In step 400, the user selects to run the password manager application 350. In response, the computer will open the password manager application 350, which will launch an xterm window opening SARTS. It should also be recognized that the password manager application 350 in some implementations includes password protection. The password protection in such implementation inhibits an unauthorized user from using an authorized user's computer, and changing the authorized user's password.

In step 405, the password manager 350 sends the user's password information to the SARTS application 120 at the server 115, logging on to the system to check the current password. The SARTS program 120 typically responds to the login. However, the response typically varies from session to session, and server to server, and the password manager 350 listens for data received from the server 115 in step 410. On any particular server 115a-e, the various responses are observed through numerous login attempts and capture of the responses to each of the login attempts. Typical expected data responses include, among others: “DESTINATION”; “POSITION IS CURRENTLY LOGGED ON”; “Microsoft Telnet>”; “TERMINALS SUPPORTED:”; “DEFAULT=vt100”; “type:”; “TO EXIT):”; “** CONNECTED **; “PRIMARY***PROCESSOR*****************************”; “MISSISSIPPI”; “000/”; “UAS COMMANDS”. The password manager 350 checks this data against a list of expected data in step 415. In step 420, the password manager determines if the expected data was received. If the expected data is not received, the password manager 350 displays an error message to the user 105 in step 425. It should be recognized that there are other responses that can be received, but typically indicate that there has been an error in logging on.

In step 430, the password manager 350 determines if the user 105 indicates a desire to change his or her password. If the user 105 does not desire to change his or her password, the password manager 350 waits until the user 105 wishes to change the password. Alternatively, in other embodiments of the present disclosure, the password manager waits until the password is approaching its expiration and alerts the user to this fact.

If the user wishes to change his or her password, the password manager 350 sends a change password request to the server 115 in step 435. Again, the password manager 350 typically awaits a response from the server 115 in step 440. The response from the server 115 typically comes in numerous forms based upon the server 115 or the time of day. Typical responses include, among others: “DESTINATION”; “COMMAND DOES NOT EXIST”; “Microsoft Telnet>”; “TERMINALS SUPPORTED:”; “DEFAULT=vt100”; “type:”; “TO EXIT):”; “** CONNECTED **; “PRIMARY***PROCESSOR*****************************”; “MISSISSIPPI”; “000/”; “UAS COMMANDS”; “U01/”; “DATE MODIFIED:”; AND “/NEW PASSWORD/NEW PASSWORD”. The password manager 350 then checks the response against the expected results in step 445. If the response is not the expected response, the password manager 350 displays an error message to the user in step 425.

If the response is the expected response, the password manager 350 typically sends the new password to the server 115 in step 450. In step 455, the password manager 350 receives a response from the server 115. The response is typically an acknowledgement (ack) in some form of acceptance or rejection of the new password. In step 460, the password manager 350 determines whether the ack was an acceptance. If the ack was not an acceptance, the password manager 350 displays an error message to the user 105. If the ack was an acceptance, the password is changed, and the next password can be changed in step 465.

One skilled in the art should understand that the error messages are typically tailored according to the problem that was encountered. For instance, if the problem occurred in step 460, the error message would alert the user that the passwords provided did not match. Moreover, the expected results could be expanded to include several erroneous messages that are received upon the occurrence of a specific error. Therefore, the error message is more specifically tailored to particular error encountered.

One skilled in the art should appreciate that while five SARTS servers 115a-e are shown with regard to the above embodiments, alternative embodiments of the present disclosure exist wherein there are not multiple SARTS servers 115. Moreover, it should be appreciated that the password manager 350 in some embodiments, among others, is configured to change the password on a SARTS server 115 one-at-a-time. Therefore, if the password for one SARTS application 120 somehow becomes misaligned with the passwords for the other applications, the user 105 is operable to change each of the SARTS passwords individually.

Process and function descriptions and blocks in flow charts can be understood as representing, in some embodiments, modules, segments, or portions of code which include one or more executable instructions for implementing specific logical functions or steps in the process, and alternate implementations are included within the scope of the preferred embodiment of the present disclosure in which functions may be executed out of order from that shown or discussed, including substantially concurrently or in reverse order, depending on the functionality involved, as would be understood by those reasonably skilled in the art of the present disclosure. In addition, such functional elements can be implemented as logic embodied in hardware, software, firmware, or a combination thereof, among others. In some embodiments involving software implementations, such software comprises an ordered listing of executable instructions for implementing logical functions and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a computer-readable medium can be any means that can contain, store, communicate, propagate, or transport the software for use by or in connection with the instruction execution system, apparatus, or device.

It should also be emphasized that the above-described embodiments of the present disclosure are merely possible examples of implementations set forth for a clear understanding of the principles of the disclosure. Many variations and modifications may be made to the above-described embodiment(s) of the disclosure without departing substantially from the principles of the disclosure. All such modifications and variations are intended to be included herein within the scope of this disclosure and the present disclosure and protected by the following claims.

1. A password management system, comprising:
graphical user interface logic operable to receive a current password from a user, prompt the user to determine whether the user desires to change the current password, and responsive to the user response receive a new password;
password confirmation logic operable to confirm the current password associated with the user on a switched access remote test system; and
password administration logic, responsive to the password confirmation logic and the graphical user interface, operable to receive the new password and to change the current password on the switched access remote test system.

2. The system of claim 1, wherein the password confirmation logic is operable to send the current password to the switched access remote test system and receive a response from the switched access remote test system.

3. The system of claim 2, wherein the password confirmation logic is operable to compare the response with a plurality of expected responses and determine whether the current password provided by the user is valid.

4. The system of claim 3, wherein the response is an alphanumeric string, and the plurality of expected responses comprises erroneous responses and successful responses.

5. The system of claim 4, wherein the password confirmation logic is operable to instruct the graphical user interface logic to provide any of a plurality of error messages to the user upon the password confirmation logic determining that the current password provided by the user is not valid.

6. The system of claim 1, wherein the password administration logic performs a password change upon receiving a request to change the password from the graphical user interface.

7. The system of claim 6, wherein the password administration logic performs a password change upon receiving a confirmation of the password from the password confirmation logic.

8. The system of claim 7, wherein the password administration logic is operable to send the current password and the new password to the switched access remote test system and receive a response from the switched access remote test system, and compare the response to a plurality of expected responses

9. The system of claim 6, wherein the password administration logic is operable to instruct the graphical user interface logic to provide any of a plurality of error messages to the user upon the password administration logic determining that the new password provided by the user was not accepted by the switched access remote test system.

10. The system of claim 1, further comprising:
a password file operable to store a set of data comprising the expiration date of the current password;
expiration logic operable to read the password file and request that the graphical user interface notify the user that the current password is nearing expiration responsive to the expiration date.

11. The system of claim 1, wherein the password management system is operable to interact with at least two switched access remote testing systems through a second graphical user interface that forms a wrapper for said at least two switched access remote testing systems.

12. A method of managing passwords, comprising the steps of:
providing a user with a graphical user interface;
receiving a current password from the user via the graphical user interface for a switched access remote test system;
prompting the user on whether to change the current password;
receiving a new password from the user responsive to the user response to the prompting;
confirming the current password with the switched access remote test system; and
requesting that the switched access remote test system change the password responsive to the user response to the prompting.

13. The method of claim 12, wherein the confirming the current password further comprises the steps of:
sending the current password to the switched access remote test system; and
receiving a response from the switched access remote test system.

14. The method of claim 13, wherein the confirming the current password further comprises the step of comparing the response from the switched access remote test system with a plurality of expected responses.

15. The method of claim 14, wherein the confirming the current password further comprises the step of notifying the user of an error responsive to the comparing step.

16. The method of claim 12, wherein the requesting that the switched access remote test system change the password responsive to the user response to the prompt step further comprises sending the new password to the switched access remote test system along with the current password.

17. The method of claim 16, wherein the requesting that the switched access remote test system change the password responsive to the user response to the prompt step further comprises receiving a response from the switched access remote test system after sending the new password.

18. The method of claim 17, further comprising the step of comparing the received response with a plurality of expected responses.

19. The method of claim 18, further comprising the step of providing an error message to the user responsive to the comparing step.

20. The method of claim 12, further comprising the steps of:
reading a password file to determine an expiration date associated with the current password; and
prompting the user to change the password responsive to the expiration date.

21. A computer readable medium having a program for managing passwords, the program operable to perform the steps of:
providing a user with a graphical user interface;
receiving a current password from the user via the graphical user interface for a switched access remote test system;
prompting the user on whether to change the current password;
receiving a new password from the user responsive to the user response to the prompting;
confirming the current password with the switched access remote test system;
requesting that the switched access remote test system change the password responsive to the user response to the prompting.

22. The computer readable medium of claim 21, wherein the confirming the current password further comprises the steps of:
sending the current password to the switched access remote test system; and
receiving a response from the switched access remote test system.

23. The computer readable medium of claim 22, wherein the confirming the current password further comprises the step of comparing the response from the switched access remote test system with a plurality of expected responses.

24. The computer readable medium of claim 23, wherein the confirming the current password further comprises the step of notifying the user of an error responsive to the comparing step.

25. The computer readable medium of claim 21, wherein the requesting that the switched access remote test system change the password responsive to the user response to the prompt step further comprises sending the new password to the switched access remote test system along with the current password.

26. The computer readable medium of claim 25, wherein the requesting that the switched access remote test system change the password responsive to the user response to the prompt step further comprises receiving a response from the switched access remote test system after sending the new password.

27. The computer readable medium of claim 26, the program further operable to perform the step of comparing the received response with a plurality of expected responses.

28. The computer readable medium of claim 27, the program further operable to perform the step of providing an error message to the user responsive to the comparing step.

29. The computer readable medium of claim 21, the program further operable to perform the steps of:
reading a password file to determine an expiration date associated with the current password; and
prompting the user to change the password responsive to the expiration date.
